(19) United States
(12) Patent Application Publication
(10) Pub. No.: US 2007/0291746 A1
(43) Pub. Date: Dec. 20, 2007

(54) System and method for managing aspects of a voice communication using a separate communication channel

(75) Inventors: Robert J. Beaton, Apohaqui (CA); John Olive, Saint John (CA); Joseph Kenneth Allison, Rothesay (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/453,150

(22) Filed: Jun. 15, 2006

(51) Int. Cl. H04L 12/66

(52) U.S. Cl. 370/356

(57) ABSTRACT

The invention provides a system, method and terminal for managing a connection request for a call originating from a voice communication network through a subscriber terminal for a video signal originating from an independent source is provided. The method comprises: receiving a message at the subscriber terminal relating to the call; generating a GUI session for a video monitor connected to the subscriber terminal to display particulars relating to the call; providing an option to further process the call through the subscriber terminal through the GUI session; if a command is received to further process the call, providing an appropriate message to the voice communication network to process the command; and if a command is received to change an aspect of the video signal, providing an appropriate message to the subscriber terminal to process the command.

### FIELD OF THE INVENTION

The invention is related to managing an aspect of one signal stream, such as a voice call, through a system handling different signal channel(s), such as a controller for a video signal.

### BACKGROUND OF THE INVENTION

Use of communication networks for distribution of entertainment, collectively referred to as “multimedia entertainment content”, or “content”, continues to gain popularity fuelled by the decreasing cost of equipment and bandwidth to the home, and emergence of interactive personalized services. These services include TV programming, pay-per-view (PPV), video-on-demand (VoD), games, as well as Internet access.

In general, at a subscriber's house, a client (receiver, decoder, set top box, or player) is connected to a television or video monitor. The client receives and processes such content from a remote video server and provides them to the television based on the user's selection through a local controller. The user has the option to select for viewing one of a plurality of channels, which are broadcast from a head-end or streamed from a server with pre-stored content files.

Also at the subscriber's house, he may have one or more telephone connection(s) providing separate voice communication channels. Typically the telephone line is not connected to the client (although it may be) and operates independently therefrom.

There is a need for a system and method to manage, process or control aspects of the telephone calls through the client.

### SUMMARY OF THE INVENTION

In a first aspect, a method for managing a connection request for a call originating from a voice communication network through a subscriber terminal for a video signal originating from an independent source is provided. The method comprises: receiving a message at the subscriber terminal relating to the call; generating a GUI session for a video monitor connected to the subscriber terminal to display particulars relating to the call; providing an option to further process the call through the subscriber terminal through the GUI session; if a command is received to further process the call, providing a message to the voice communication network to process the command; and if a command is received to change an aspect of the video signal, providing a message to the subscriber terminal to process the command.

In the method the GUI session may be terminated automatically after a set period of time if no command is received at the subscriber terminal relating to the call or to the video signal.

In the method, when the command is to forward the call to a voice message system, the subscriber terminal may provide a command to the voice communication network to route the call to the voice message system.

In the method, the message may be received as a separate signal while the call is being processed by its associated network.

In the method, the message may be generated from a server associated with a network processing the call after the ancillary server receives particulars about a called party for the call and matches the particulars against a database.

In the method, the database has data to correlate addressing information about the subscriber terminal with the number of the called party.

In the method, the GUI session may be terminated by a message received at the subscriber terminal indicating that the call has been answered or has been terminated.

In a second aspect, a subscriber terminal for managing a connection request for a call originating from a voice communication network and for managing a video signal originating from an independent source is provided. The subscriber terminal comprises: a first module to receive a message relating to the call; a second module to generate and control a GUI session for a video monitor connected to the subscriber terminal to display particulars relating to the call; a third module to receive and process a response signal from a viewer at a video monitor connected to the terminal and displaying the GUI session; a fourth module to generate and send a response message to the voice communication network to process the command when a command is received to further process the call; and a fifth module to generate and initiate a command relating to the video signal when a command is received to change an aspect of the video signal.

In the terminal, the second module may terminate the GUI session automatically after a set period of time if no command is received at the subscriber terminal relating to the call or the video signal.

In the terminal, when the command is to forward the call to a voice message system, the controller may provide a command to the voice communication network to route the call to the voice message system.

In the terminal, the message may be received as a separate signal at the terminal while the call is being processed by its associated network.

In the terminal, the message may originate from a server associated with a network processing the call after the ancillary server receives particulars about a called party for the call and matches the particulars against a database.

In the terminal, the database may have data to correlate addressing information about the subscriber terminal with the number of the called party.

In the terminal, the second module may terminate the GUI session when a message received at the subscriber terminal indicating that the call has been answered or has been terminated.

In a third aspect, a system for processing a call and an independent video signal at a site is provided. The system comprises: a subscriber terminal for managing a connection request for the call originating from a voice communication network and for managing the video signal originating from an independent source; a database accessible by the ancillary server, containing data relating to called numbers and subscriber terminals; and a server associated with a network processing call. The subscriber terminal comprises: a first module to receive a message relating to the call; a second module to generate and control a GUI session for a video monitor connected to the subscriber terminal to display particulars relating to the call; a third module to receive and process a response signal from a view at a video monitor connected to the terminal and displaying the GUI session; a fourth module to generate and send a response message to the voice communication network to process the command when a command is received to further process the call; and a fifth module to generate and initiate a command relating to the video signal when a command is received to change an aspect of the video signal. The server receives particulars about the call originating from the network and accesses the database to search for an entry therein relating to the subscriber terminal and the call and then generates a signal to send the message to the subscriber terminal.

In the system, the second module may terminate the GUI session automatically after a set period of time if no command is received at the subscriber terminal relating to the call or the video signal.

In the system, the message may be received as a separate signal at the terminal while the call is being processed by its associated network.

In the system, in the terminal the second module may terminate the GUI session when it receives a message indicating that the call has been answered or has been terminated.

The system may further comprise a second subscriber terminal associated with a calling party for the call to receive another signal from the ancillary server relating to the status of the call to initiate another GUI session controlled by the second subscriber terminal. Also the database further comprises data relating to the calling party.

In the system and method, the message may also be used by the subscriber terminal to adjust downward an audio signal associated with video signal while the GUI session is active.

In other aspects, various combinations of the sets and subsets of the above noted combinations are provided.

### BRIEF DESCRIPTION OF THE DRAWINGS

Aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIG. 1 is a block diagram of a video server network and a voice communication network each providing a connection to a site, where a client, such as a set top box associated with the video server network provides video signals to a television and also provides control over aspects of calls connecting a telephone at the site to the voice communication network according to an embodiment;

FIG. 2 is a block diagram of the set top box of FIG. 1;

FIG. 3 is a flow chart of a call being established and processed by the network of FIG. 1;

FIG. 4 is an exemplary graphical user interface (GUI) generated by the set top box on the television of FIG. 1 during processing of a telephone call destined for a telephone device at the same site of the set top box of FIG. 1; and

FIG. 5 is a flow chart of processes executed by the set top box on the television of FIG. 1 during processing of a telephone call.

### DETAILED DESCRIPTION

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

Briefly, an embodiment provides a system and method of managing, processing and controlling aspects of a communication channel, such as a telephone call for a telephone at a site through a different communication channel, such as through a set top box associated for a television located at that site. In one aspect, a call is initiated to the telephone and the set top box is provided with a separate signal indicating same. The set top box can then provide a GUI to the user to notify the user of the call (independently of any ring tones being generated at the telephone itself). Depending on controls and signals available to set top box relating to the telephone call, parts of the call (for example, call establishment parts) may be processed through the set top box or alternatively or additionally, aspects of the video signal processed through the television may be changed to accommodate an aspect of the call (for example, a GUI may be selectively generated in conjunction with the video signal, where the GUI provides information and options relating to the call).

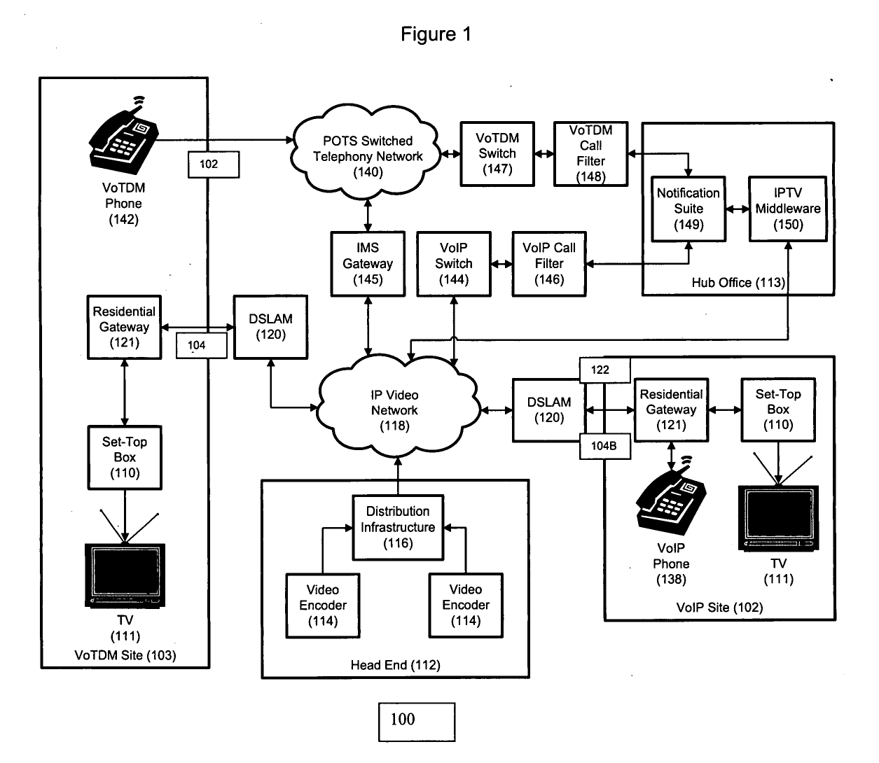

Further detail on an embodiment is provided in FIG. 1 showing system 100, where at site 103, separate video and telephone connections 104 and 106 may be provided through separate connections. Meanwhile, at site 102, system 100 provides a single connection 104B for both telephone and television signals where the connections can still be processed as separate logical connectors.

First, a description is provided on video processing and distribution aspects of an embodiment. At each site 102 and 103, television 111 is connected to an on-site set top box (STB) 110, which receives video signals from network 118 through an external server 120, which provides the signals to a local residential gateway 121 through a local connection, which then forward the signals to the STB 110. As will be described below, the connection also receives call information relating to a call destined for telephone 138, 142 on site.

STB 110 represents any type of subscriber terminal that is enabled with a display for viewing the content received from server 120, such as a subscriber terminal box, a CD or DVD player, a personal computer (PC), etc. As is known to those of skill in the art, STB 110 includes decoder 132 for converting the content of the elementary streams of multimedia content streams into the respective audio and video information, an IPG (interactive program guide) application 134 that enables the user to view and select the he content of interest from the server, and ordering module 136 that transmits membership requests for reception by the listening module 126 of server 120.

Ultimately, video signals provided to STB 110 originate from one or more video sources connected to network 118. Network 118 may be a packet-switched network, such as an IP network. Exemplary video sources include a head end 112 and one or more hub offices 113 that each individually connect to network 118. In other embodiments, other network configurations may be provided to feed video signals to STBs 110.

In one distribution configuration, head end 112 provides a centralized, a “national” video channel distribution centre for sending video signals to the STBs 110. The channels provided by head end 112 are multicast through network 118 to all STBs 110. Each STB 110 can selectively tap into one (or more) of the channels. Head end 112 comprises one or more video encoders 114 that process the central video signals into a transmittable format and provide them to distribution infrastructure 116 for data encapsulation, addressing and transmission to network 118. Meanwhile each hub office 113 connected to network 118 is itself associated with a set of STBs 110. Each hub office 113 provides local channels that are multicast to its set of STBs 110 in addition to channels provided by head end 112. As such, a hub office 113 may also have a corresponding video encoder and distribution infrastructure (not shown) to generate and distribute its local channels. Each hub office 113 may also provide control signals or commands to its set of locally connected STBs 110.

Video signals destined for STB 110 are encapsulated into packets addressed to server 120, which acts as a server for all video signals provided to STB 110. Server 120 receives encoded streams from head end 112 through network 118 and streams the multimedia entertainment content to one or more STBs 110 upon request. Server 120 may be conveniently provided in a digital subscriber line access multiplexer (DSLAM) or within any network device already present close to the edge. For the embodiment shown, the DSLAM sends unicast packets to individual lines 122.

Server 120 includes a synchronization module, a listening module, receiver for receiving the content streamed from head end 112 and sender module for each STB 110 that plays back the content offered by the server 120 at a certain moment. While none of these modules is shown in FIG. 1, it will be appreciated that they may be implemented in an appropriate set of software, firmware or hardware modules that can generate and process such messages and commands there between.

In server 120, synchronization module tracks milestones that occur in each stream, for enabling each STB 110 to receive the channel it requests, starting with the most recent milestone in the stream after the announcement has been received by server 120. Receiver module inserts the packets in the multicast transport stream in a circular buffer of the synchronization module and tracks the real-time position of the STBs 110 in the buffer, i.e. it tracks the position in the buffer of the packet that is currently sent by the respective sender module to the associated STB 110. The position of each sender module in the buffer is tracked from the most recent milestone at the moment a respective client requested the channel. Since requests from each client come at different times, each client is at a different position in the buffer.

Listening module generates and transmits messages on a periodic basis to query which clients (STBs 110) that have notified server 120 that they wish to receive multicast traffic. The messages generated by the clients, called membership reports or requests, provide requests to join or leave specific multicasts and indicate the subscriber client multicast address. Listening module examines the reports and either enables or disables forwarding of that particular multicast. Other mechanisms for detecting a channel change request may be equally used, such as an unicast listening HTTP mechanism, (i.e. listening module may be a HTTP/Javascript interface, which is also available on set top boxes), or an RTSP mechanism. Advantageously, if detection of requests is implemented using IGMP snooping, the solution according to the invention will support multicast security enhancements and would time-out clients that no longer respond to Internet Group Messaging Protocol (IGMP) queries.

Now, a description is provided on voice communications processing aspects of an embodiment, that can be processed separately and independently of the video signals. Generally, voice communications are provided as telephone systems through two network architectures: switched and packetized networks. First, a switched network can be implemented as a plain old telephone service (POTS) network 140. At site 103, telephone 142 is connected to exemplary POTS network 140 through connection 106, which is separate from connection 104 relating to its STB 110. The POTS network provides a circuit-switched network connecting the calling party to a called party (either in the switched network or in another network). The POTS network may provide a digital connection system such as a time division multiplex (TDM) system. Call management features for network 140 are provided in part by TDM switch 147 and TDM call filter 148. Second, an exemplary packetized network is a Voice-over IP (VoIP) telephone network, which may be implemented using the packet-based architecture of network 118. At site 102, telephone 138 is connected to VoIP network 118 through residential gateway (RG) 121 and STB 110. VoIP switch 144 and VoIP call filter 146 are connected to network 118 to provide call management features for its calls, akin to TDM switch 147 and TDM call filter 148.

For POTS network 140 and VoIP network 118, an IP multimedia subsystem (IMS) gateway 145 is provided to connect the two networks and to allow voice data and communications to be exchanged between the networks and then subsequently processed by the receiving network. As such, IMS gateway 145 provides appropriate addressing and other information for data, packets and signals relating to calls handled between the two networks, for example for a call involving telephones 138 and 142.

When a call is being established and resources and routes are being negotiated through the networks from its originating location (e.g. calling party from the originating communication device) to its destination(s) (e.g. called party at the destination communication device), a suite of call management features is available for the call. Both voice communication networks can process such management features. The features are processed, at least in part by a local switch 144, 147. Call management features include providing call routing information when an inbound or outbound call is being made by a telephone in its network. Such features are provided through signals and may include: caller identification signals, call forwarding signals, call block signals, call display signals, voice mail initiation signals and other call management signals and features provided for calls as known to those skilled in the art. When an initiating telephone initiates a call, the routing parameters, forwarding parameters and call resource management parameters may be provided by the switch associated with its network through appropriate signal(s) or messages. Alternatively, other elements in the network of the called party may provide some routing parameters. As such, the switch can monitor for new calls and receive, extract and process the parameters of the call. In an embodiment, switch 144, 147 processes some or all call routing information signals for calls processed by network 140 and provides a summary of selected calls to network 118. Such signals may be provided to SIP switch 144 and be extracted by filter 146 to identify a corresponding message that can be sent to STB 110. Provisioning of such information is provided through monitoring systems and techniques known in the art.

In a VoIP network, switch 144 may be provided by an interface switch, such as a session interface protocol (SIP) switch. Such SIP interface systems are known in the art and include, as an example, Alcatel switch 5020 (trade-mark). SIP is an ASCII protocol that can be used to assist in establishing, modifying and executing communication sessions between one or more participants. For the exemplary situation where a telephone call is being established between (remote) telephone 142 and telephone 138 in site 102, filter 146 receives call particulars (including all calling and called identification parameters relating to the parties. SIP filter 146 provides call routing information for elements in networks 140 and 118. It can be an ancillary server to the main network. Different servers may provide different details of information. Where other network architectures use the same network to process signals from voice and video systems (e.g. VoIP voice signals and IP television signals), filter 146 may be connected to that network and provide connections and data to both systems.

For both networks, filter server 146, 148 is connected to each associated switch 144, 147. Each filter can monitor the call management traffic being processed by its associated switch. A switch receives details about an initiated call and generates equivalent message(s) relating to the call (e.g. “invite”, “trying” and “ringing”) and provides the message(s) to filter 146.

Filter 146, 148 can extract selected call data and further process it to provide additional features for call. For example, when a call is initiated and the call parameters are processed by the associated switch, the associated filter can extract this information. Thereafter the filter can generate ancillary messages that may be sent to ancillary devices associated with the called telephone. The ancillary devices can then provide additional call processing features for the call, thereby enhancing the user environment for the call. Alternatively or additionally, the filter can generate signals that are further processed by other elements, which then generate messages that may be sent to ancillary devices associated with the called telephone. Further still, additional messages and signals may be sent to any ancillary devices associated with the calling party.

A notable element for providing additional features for a call is a database of calling and called parties that is accessed by filter 146, 148. It will be appreciated that several types of databases can be provided and maintained for the filter to provide information on the called and calling parties. One exemplary database includes a list of sites, their associated land telephone numbers and their associated STBs 110. The data for this database can be provided to the filter from each hub office 113. The filter can then amalgamate the data into a larger database. Other mappings of video devices communicating through network 118 can be provided, including a mapping of all STBs 110 or similar devices associated with head end 112 or mappings of all head ends 112 associated with a particular STB 110. Additional “buddy lists” or preference lists for contacts can be provided for a particular calling or called party. The databases may also be maintained by a server system in hub office 113 or head end 112 that pushes that data down to each connected filter.

Using such exemplary databases, a filter can identify additional information about a call by correlating details about the call provided by the switch (such as the calling and called numbers) against databases accessed by filter 146, 148. Using the results of the database searches, the filter can then identify different associations for the called (or calling) number to other elements in the system. Such associations may include identifying a corresponding site and STB associated with the telephone at the called (or calling) number. Such associations can then be used to provide additional signals to other elements associated with the call. It will be appreciated that various database maintenance systems and mining techniques known to those skilled in the art can be used by filter 146 to identify any such associations.

For example, once one or more associations are identified for a called number, the filter can then initiate a further direct or indirect message ultimately destined to the STB associated with the called number. The STB may be programmed to receive and respond to such message by providing additional call processing features relating to the call through the television associated with it.

In the embodiment, hub office 113 provides a convenient communication point between filter 145, 147 and STBs 110, since the hub office is already in communication with its group of STBs through network 118. Hub office 113 also receives additional information about telephone calls, both calls initiated from various telephony networks (e.g., TDMA, VoIP and others) and other communication devices and networks (e.g., e-mail, PDAs, etc.).

When the filter finds a record for the called party in its database identifying a related STB and hub office, the embodiment can then provide additional information about the call to the television associated with the STB. The embodiment accomplishes this by generating and sending a command to provide information about the call to identified STB.

First, a signal identifying the STB is generated and sent from the filter to the hub office (as identified in the database). The signal is received at a notification suite 149 in the hub office. The notification suite is responsible for receiving any signals or messages from any filter, extracting the called party data therefrom and generating a command to be sent to the STB associated with the called number. The command may be to generate a specific GUI on the television associated with the call, providing information about the call. The command is provided to middleware module 150. Middleware module receives command signals from various internal and external sources, then packages and addresses them into an appropriate message packet for transmission through network 118 for ultimate delivery to the STB 110 associated with the called number for the receiving telephone. Outgoing messages may be provided in various format, including an IP-protocol may be used such as formats and parameters defined by Microsoft's television initiative MSTV (trademark). When such services are provided as web services, any suitable web-based protocol may be used for message handling among elements, including XML and Simple Object Access Protocol (SOAP).

When a particular STB receives the command from a hub office, the STB may then generate specific notifications to the television set. As such, the STB may relay to the user at the site information about the telephone call to his television set through a GUI.

For some GUIs, the user is provided with the option of providing a responding command for the call (e.g. answer the call). For such a responding command, when the STB receives the responding command, the STB can then generate a responding message that is sent to the hub office and the middleware module. The middleware module then provides the responding command to the notification module and the notification module can generate and send a signal containing the responding command to the associated filter. Once the filter receives the signal containing responding command, it can then provide the command to the switch, which can then process the command for the call.

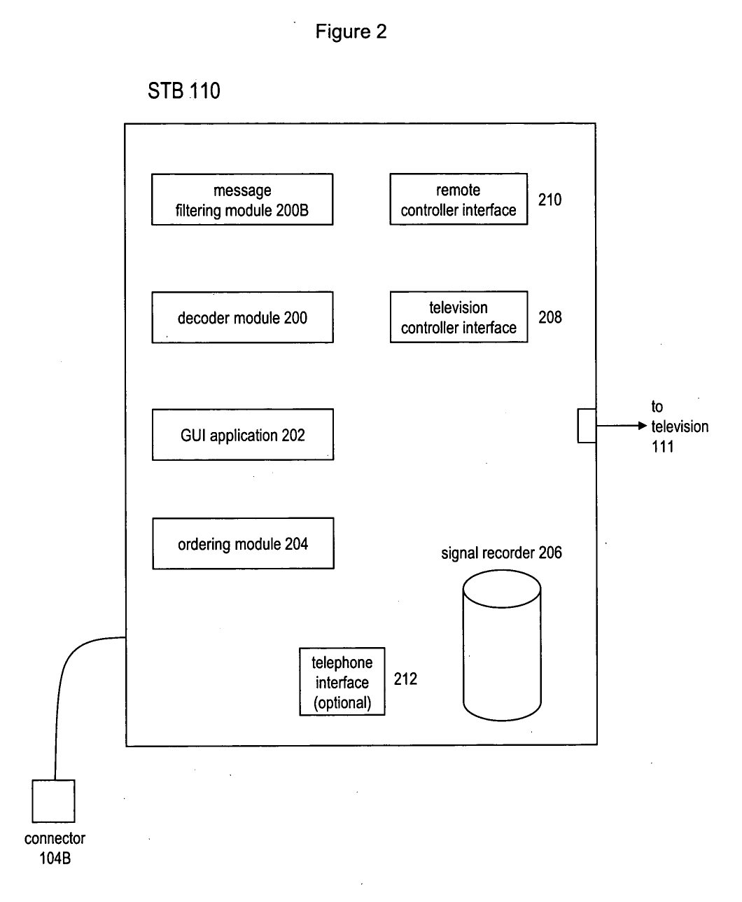

Referring to FIG. 2, elements of STB 110 are provided. As noted earlier, STB 110 comprises signal decoder module 200 (with message filtering module 200B), GUI application generator module 202 and program ordering module 204. STB 110 also comprising data storage unit 206 for recording video signals “on the fly”. Such recordings may be done to a semi-permanent storage device such as RAM or a hard drive. Television control interface 208 provides commands to control the connected television 111 (e.g. volume control). Remote control interface module 210 provides the routines to accept and process commands from the remote control (e.g. volume control, pause video signal etc). Telephone control interface module 212 provides an optional direct connection to telephone 138. Depending on the call message received by STB 110, it can generate one or more GUIs that will be displayed on the connected television 111. While the GUIs provide only displayed information on television 108, they also present options for controlling either one or both of the associated call (currently presumably ringing on telephone 138) or the video program being channelled through STB 110 from head end 112 or hub office 113 to television 111.

A description is provided on exemplary types of calls that may be processed by an embodiment. With networks 140 and 118, four types of calls may be established:

(1) a POTS to POTS call;

(2) a POTS to VoIP call;

(3) a VoIP to VoIP call; and

(4) a VoIP to POTS call.

### The processing of the call vis-à-vis switch 144, 147 and filter 146, 148 are described in turn.

For a POTS to POTS call, TDM switch 147 receives the called and calling party data. Next, TDM filter 148 extracts the called data information and provides a suitable command to notification suite 149 in the respective hub office 113. Next, notification suite 149 provides a suitable command for middleware 150 that then sends an appropriate command to network 118 for routing to set top box 110. In a POTS to VoIP call, the call is first routed from POTS network 140 through IMS gateway 145 to IP network 118. Then, VoIP switch 144 extracts the calling the called party data and provides it to VoIP call filter 146. The called party data is processed in a similar manner as noted above for the TDM filter and a suitable notification command is sent to hub office 113 through notification suite 149. Middleware module 150 ultimately generates and sends an appropriate command to the appropriate set top box 110. For a VoIP to VoIP call, the VoIP switch 144 obtains the called party data and the VoIP call filter extracts and processes the called data. A command is ultimately sent to the appropriate STB as noted above. For a VoIP to TDMA call, the call is processed from IP network 118 through IMS gateway 145 to POTS network 140. Thereafter, TDM switch 147 picks up the called party data and TDM call filter 148 extracts the data. Again, a command is ultimately sent to the appropriate STB as noted above.

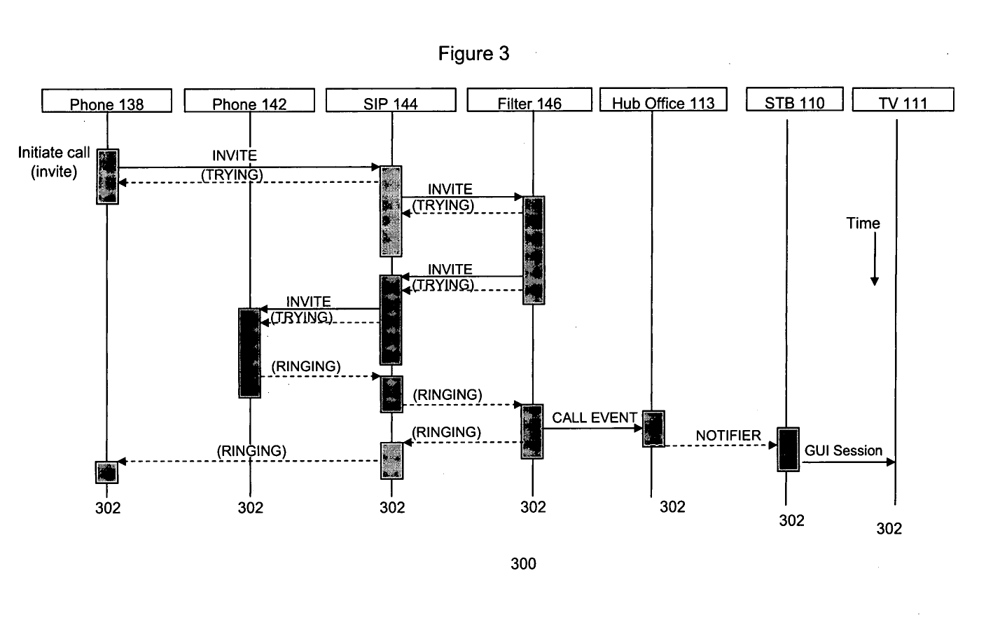

Referring to FIG. 3, chart 300 shows a progression of messages generated and processed in a VoIP-to-VoIP telephone call between telephones 138 and 142. The messages are processed through switch 144, filter 146, hub office 113 (comprising notification module 149 and middleware module 150), STB 110 and television 108 during initiation of the call by telephone 138 and the subsequent answering of the call by telephone 142. Chart 300 shows each element along the top row. Lines 302 emanating downward from each element represent timelines. Boxes along the timelines represent specific processes being executed by the element at that particular time. Horizontal arrows connecting boxes indicate messages that are generated by the process at the base of the arrow and are sent to another process at the tip of the arrow.

When a process receives a message, it processes the message and may initiate internal commands and response message(s). Starting from the top left corner of chart 300, telephone 138 initiates a call that is destined to telephone 142, as noted per the initiate call block. The initial message that is generated for the call is an “invite” message generated by telephone 138, which is sent to SIP switch 144. The “invite” message includes call management data such as the called number of telephone 138. As an initial acknowledgement, SIP switch 144 generates and sends a “trying” message back to telephone 138. Next, a monitoring process between SIP switch 144 and filter 146 causes the initial “invite” message to be detected at SIP switch 144 and forwarded to filter 146 in a subsequent “invite” message. When filter 146 receives the message, it generates and sends a “trying” acknowledgement message back to SIP switch 144. At this time, filter 146 can, if prompted, extract call management information from the subsequent “invite” message and assess it against data in its database. This completes an upstream portion of the call request, where a connection invitation is sent upstream from the originating telephone 138 to SIP switch 144.

The corresponding downstream portion of the call request involves routing the call through network 118 using routing parameters provided by switch 144 and attempting to make a connection to the called telephone 142. For this embodiment, filter 146 sends back to switch 144 an “invite” and a “trying” message to a call connection process in switch 144. The call connection process is responsible for completing the connection request for the originating call. As such, upon receiving the “invite” message, it generates and sends an “invite” and a “trying” message to a call receiving process in telephone 142. At this time, telephone 142 can initiate an audible “ringing” signal.

After initiating the “ringing” signal, telephone 142 needs to update elements in the call of its current status. As such, telephone 142 generates a “ringing” message and sends it to switch 144 through network 118. When switch 144 receives the “ringing” message, switch 144 generates and sends a corresponding “ringing” message to filter 146. The message can include identification details about the calling and called parties. When filter 146 receives the “ringing” message, it extracts the called party information therefrom and compares it against the database for a match to a corresponding STB associated with telephone 142. On the presumption that a match is found, filter 146 generates and sends a “call event” message to hub office 113, in order to have hub office 113 generate an appropriate message to the corresponding STB.

When hub office 113 receives the “call event” message, notifier 149 extracts the called party information from the message and generates a message ultimately destined for corresponding STB 110 to initiate a GUI command its attached television 111. That message is provided to middleware 150 for encapsulation, addressing and transmission as a “notifier” message through network 118 for STB 110. When the corresponding STB 110 receives the “notifier” message, it extracts the command and initiates the generation of the requested GUI on television 111.

In the meantime, after filter 146 receives the “ringing” message from switch 144, calling telephone 138 needs to be notified that the called telephone 142 is ringing. As such, filter 146 generates and sends an acknowledgement “ringing” message to switch 144. Subsequently switch 144 generates and sends a further acknowledgement “ringing” message to telephone 138. Thereafter, telephone 138 can locally generate a “ringing” tone in the earpiece of its receiver.

It will be appreciated that for other status events for a call (e.g., called telephone is busy, called telephone has gone off hook to complete the call, called telephone has gone back on hook to terminate the call, etc.), other messages may be initiated to be sent by filter 146 to STB 110. STB 110 can then selectively process the information in the message to update the GUI session. For example, if a subsequent message is that the call has been answered or that the calling party has hung up its telephone, then STB 110 may terminate the GUI session.

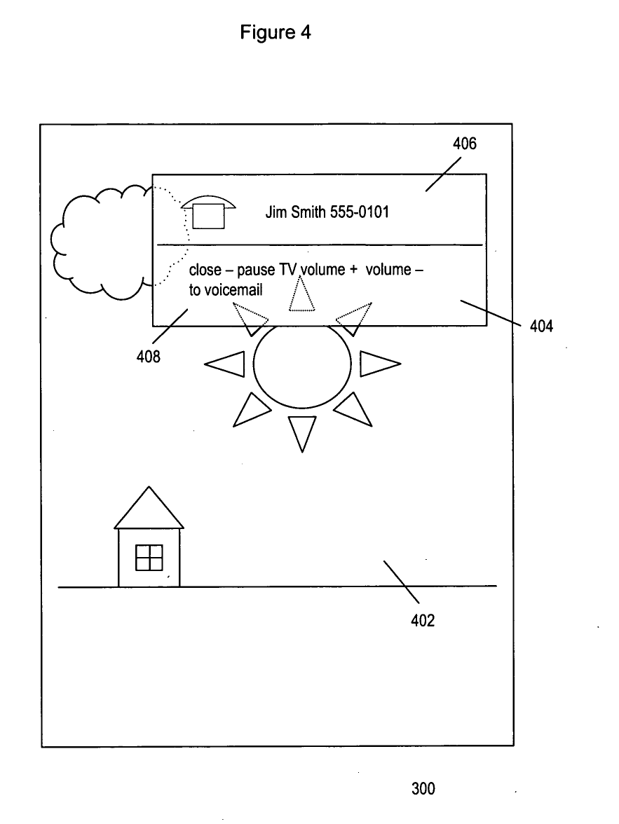

Referring to FIG. 4, further detail is provided on exemplary GUIs generated by STB 110 when processing a call. The embodiment provides at least four commands that can affect either the call, the video program currently processed by the STB 110 or both. It will be appreciated that in other embodiments a different set of commands (either less or more) may be provided. Each command for this embodiment is discussed in turn. It will be appreciated that one or more GUIs may be presented to the user when processing a call in a GUI session.

Screen shot 400 is shown that is generated by STB 110 on television 108. Screen shot is one of a multiple images produced by STB 100 for television 108 to provide a “moving image”. For the sake of clarity, only one image generated by STB 110 is provided. Shot 400 comprises main video snapshot 402 with a GUI 304 imposed thereon. GUI 304 may be displayed for a limited time, as to not permanently interfere with the ongoing video transmission of image 402. Preferably, GUI 404 provides a window of information that is clearly distinctive from the ongoing image 402. However, visual enhancements may be provided to the GUI to ensure that the GUI is both prominent, but not too overbearing. For example, GUI 404 may be generated in a large window, but may have a translucent background, allowing the native video image 402 to be produced “behind” GUI 404. Additionally, the present volume of the audio signal associated with the video signal may be decreased or muted by a signal from the STB sent to the television while the GUI session is active on the television.

In area 406 of GUI 404, basic call information is provided, if it is extracted from the message. Such information includes the number of the calling party, any personalization information associated with the calling party and the time of the call.

Several commands 408 allow the user of the remote controller to initiate a command that will control either an aspect of the call or the video signal. Once the GUI is displayed, any commands received from the controller are processed through remote controller interface 152 to identify the appropriate command and to cause the command to be initiated.

One command is to forward the call immediately to a voice mail system. If this option is selected on the remote controller, then the controller generates a “send call to voice message” command, which is provided to STB 110, which then repackages the command in an appropriate message for transmission through network 118 for forwarding ultimately to switch 144. Once switch 144 receives the message, it repackages the command in an appropriate message the call processing server 140A associated with network 140 to the reroute the intended call from the number associated with telephone 138 with the voice message mail box associated with same. Of course, this routing system works well with telephone networks that have centralized voice message mail box systems. If telephone 138 has a local voice mail recording device (not shown), this routing system will only work if it can communicate with and control the local recording device.

Another command is to adjust the volume of the audio signal associated with the native video signal. If this option is selected on the remote controller, then the controller generates an appropriate “adjust volume” command, which is provided to STB 110, which then adjusts the volume of the audio signal accordingly (either up or down and terminate call when volume is decreased to a predetermined level). Such commands may be initiated through television controller 150.

Another command is to pause the video (and audio) stream of the native video signal. If this option is selected on the remote controller, then the controller generates an appropriate “pause signal” command, which is provided to STB 110, which then stops providing the audio and video signal to the television as appropriate. During the “pause” status, an appropriate “pause” message may be generated by STB 110 on television 108. To clear the “pause” status, the user would either deactivate the “pause” control button on the controller or would activate another appropriate command (e.g. stop, resume, fast forward, rewind, etc.). If STB 110 provides for video recording of the current video signal through recorder 148, then, the pause command may selectively engage the record function on the STB 110.

Another command is to close GUI 304. Activation of this command provides an instruction to STB 110 to remove the GUI. Optionally, the STB will also send a message to the hub office to cancel subsequent sending of additional messages to the STB relating to the call.

It will be appreciated that other call commands or video commands may be implemented in the GUI session. It will further be appreciated that one or more GUI sessions may be generated on other STBs and televisions associated with the call. For example, a complementary GUI session may be provided on the calling party's STB, based on another signal sent from the filter to the calling party's hub office, using a similar database analysis and signal and message generation scheme as noted earlier. The calling party GUI session may include status information about the call on the local television.

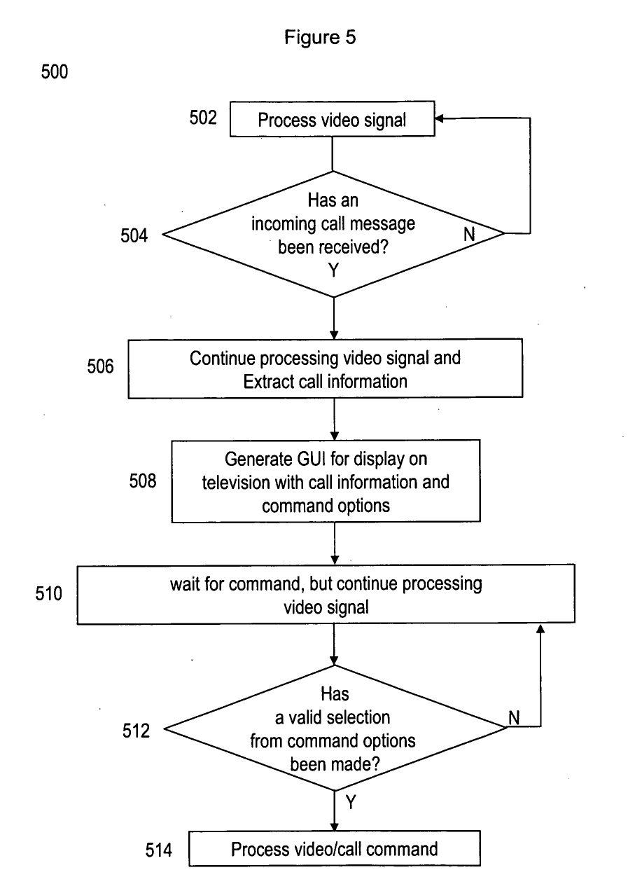

Referring to FIG. 5, a basic flow chart 500 of processing of input and output signals is provided for STB 110 when a call message signal has been received from hub office 113. At step 502, a video signal is being process as normal. At step 504, a loop test is initiated where STB 110 waits for an incoming call message. If no message is received, then the STB returns to step 502. If an incoming call has been received, then at step 506, STB 110 continues to process the video signal and then extracts call information from the message. Next at step 508, STB 110 generates a GUI for display on television with call information and command options. Next at step 510, STB 110 waits for command from the remote controller, but continues to process the video signal. At step 512, once a command is received it is tested to see if it is a valid command. If it is valid, then at step 514, the video/call command is processed. If it is not valid, then the process returns to step 510.

In other embodiments, a series of separate processes may be provided that collectively implement the processes shown in FIG. 5. In particular, the processes may operate independently of the others and communicate with each other by messages or semaphores. Other programming architectures may be provided using techniques known in the art.

It will also be appreciated that the network architectures, ancillary switches, servers and databases described herein relating to the embodiments may be implemented using techniques and technologies known to those skilled in the art to implement the features of the embodiments.

It will be appreciated that the embodiment has been for a telephone connection 106 being provided outside of STB 110 for a particular site. It will be appreciated that in other embodiments, one or more of connections 106 to network 140 or a separate connection to telephone 138 may be provided to STB 110.

Further, it will be appreciated that while the embodiment is generally described as controlling aspects of a (voice) telephone call through a separate video STB, it will be appreciated that other embodiments may be provided to control various combinations of video, audio, telephone and other signals through a central system.

Further still, it will be appreciated that all of the modules, processes, data bases, data processing data transmission, signals, packets, messages and other features and techniques described herein may be implemented in software, firmware and hardware processes and designs using known techniques of those skilled in the art.

Although the invention has been described with reference to certain specific embodiments, various modifications thereof will be apparent to those skilled in the art without department from the scope of the invention.

We claim:

1. A method for managing a connection request for a call originating from a voice communication network through a subscriber terminal for a video signal originating from an independent source, the method comprising:
receiving a message at the subscriber terminal relating to the call;
generating a GUI session for a video monitor connected to the subscriber terminal to display particulars relating to the call;
providing an option to further process the call through the subscriber terminal through the GUI session;
if a command is received to further process the call, providing a message to the voice communication network to process the command; and
if a command is received to change an aspect of the video signal, providing a message to the subscriber terminal to process the command.

2. The method for controlling an aspect of a telephone call as claimed in claim 1, wherein the GUI session is terminated automatically after a set period of time if no command is received at the subscriber terminal relating to the call or to the video signal.

3. The method for controlling an aspect of a telephone call as claimed in claim 2, wherein the command is to forward the call to a voice message system and the subscriber terminal provides a command to the voice communication network to route the call to the voice message system.

4. The method for controlling an aspect of a telephone call as claimed in claim 2, wherein the message is received as a separate signal while the call is being processed by its associated network.

5. The method for controlling an aspect of a telephone call as claimed in claim 2, wherein a server associated with a network processing the call generates a signal to generate the message after the ancillary server receives particulars about a called party for the call and matches the particulars against a database.

6. The method for controlling an aspect of a telephone call as claimed in claim 2, wherein the database has data to correlate addressing information about the subscriber terminal with the number of the called party.

7. The method for controlling an aspect of a telephone call as claimed in claim 2, wherein the GUI session is terminated by a message received at the subscriber terminal indicating that the call has been answered or has been terminated.

8. A subscriber terminal for managing a connection request for a call originating from a voice communication network and for managing a video signal originating from an independent source, the subscriber terminal comprising:
a first module to receive a message relating to the call;
a second module to generate and control a GUI session for a video monitor connected to the subscriber terminal to display particulars relating to the call;
a third module to receive and process a response signal from a viewer at a video monitor connected to the terminal and displaying the GUI session;
a fourth module to generate and send a response message to the voice communication network to process the command when a command is received to further process the call;
a fifth module to generate and initiate a command relating to the video signal when a command is received to change an aspect of the video signal.

9. The subscriber terminal for managing a connection request for a call as claimed in claim 8, wherein the second module terminates the GUI session automatically after a set period of time if no command is received at the subscriber terminal relating to the call or the video signal.

10. The subscriber terminal for managing a connection request for a call as claimed in claim 9, wherein the command is to forward the call to a voice message system and the controller provides a command to the voice communication network to route the call to the voice message system.

11. The subscriber terminal for managing a connection request for a call as claimed in claim 9, wherein the message is received as a separate signal at the terminal while the call is being processed by its associated network.

12. The subscriber terminal for managing a connection request for a call as claimed in claim 9, wherein the message is generated from a server associated with a network processing the call after the ancillary server receives particulars about a called party for the call and matches the particulars against a database.

13. The subscriber terminal for managing a connection request for a call as claimed in claim 9, wherein the database has data to correlate addressing information about the subscriber terminal with the number of the called party.

14. The subscriber terminal for managing a connection request for a call as claimed in claim 9, wherein the second module terminates the GUI session when a message received at the subscriber terminal indicating that the call has been answered or has been terminated.

15. A system for processing a call and an independent video signal at a site, comprising:
a subscriber terminal for managing a connection request for the call originating from a voice communication network and for managing the video signal originating from an independent source, the subscriber terminal comprising:
a first module to receive a message relating to the call;
a second module to generate and control a GUI session for a video monitor connected to the subscriber terminal to display particulars relating to the call;
a third module to receive and process a response signal from a view at a video monitor connected to the terminal and displaying the GUI session;
a fourth module to generate and send a response message to the voice communication network to process the command when a command is received to further process the call; and
a fifth module to generate and initiate a command relating to the video signal when a command is received to change an aspect of the video signal;
a database accessible by the ancillary server, containing data relating to called numbers and subscriber terminals; and
a server associated with a network processing the call, the server receiving particulars about the call originating from the network and accessing the database to search for an entry therein relating to the subscriber terminal and the call and then generating a signal to send the message to the subscriber terminal.

16. The system for processing a call and an independent video signal at a site as claimed in claim 15, wherein the second module terminates the GUI session automatically after a set period of time if no command is received at the subscriber terminal relating to the call or the video signal.

17. The system for processing a call and an independent video signal at a site as claimed in claim 15, wherein the message is received as a separate signal at the terminal while the call is being processed by its associated network.

18. The system for processing a call and an independent video signal at a site as claimed in claim 15, wherein the second module terminates the GUI session when a message received at the subscriber terminal indicating that the call has been answered or has been terminated.

19. The system for processing a call and an independent video signal at a site as claimed in claim 15, wherein the database further comprises data relating to the calling party and the system further comprises a second subscriber terminal associated with a calling party for the call for receiving another signal from the ancillary server relating to the status of the call to initiate another GUI session controlled by the second subscriber terminal.

20. The system for processing a call and an independent video signal at a site as claimed in claim 15, the message is also used by the subscriber terminal to adjust downwardly an audio signal associated with video signal while the GUI session is active.
